(19) United States
(12) Patent Application Publication
(10) Pub. No.: US 2002/0029197 A1
(43) Pub. Date: Mar. 7, 2002

(54) Method and system for billing over a wireless application protocol gateway

(76) Inventors: Kari Kailamaki, Espoo (FI); Sanjay Khurana, Oakton, VA (US); Matti Suomalainen, Espoo (FI)

Correspondence Address: LOTT & FRIEDLAND, P.A., P.O. BOX 141098, CORAL GABLES, FL, 33114-1098, US

(21) Appl. No.: 09/860,341

(22) Filed: May 18, 2001

Related U.S. Application Data
(60) Provisional application No. 60/203,085, filed on May 9, 2000.

(51) Int. Cl. G06F 17/60

(52) U.S. Cl. 705/40

(57) ABSTRACT

The present invention is a method and system for implementing the billing features of a Wireless Application Protocol (WAP) Gateway. The system provides for billing on multiple plans that can vary the method of billing, the time of payment, the entity responsible for payment, and the price of various services offered. In addition, the system allows for billing of individuals or groups of individuals on a uniform billing plan. The Gateway collects billing data in an information database from which data can be transferred to a separate billing system in a standard format. Because the billing data output from the information database is in the same format as all common telephone billing systems, billing for services used through the Gateway is very convenient. The billing system also provides for identification of individual users based upon a bearer address (e.g. MSISDN, telephone number, or IP address) for authorization and billing purposes. Billing can be implemented solely by the WAP Gateway billing system or in conjunction with other entities, such as an Internet service provider.

### CLAIM OF PRIORITY

This application is related to provisional application Ser. No. 60/203,085 filed on May 19, 2000 based upon which priority is claimed pursuant to 35 U.S.C. § 119(e).

### TECHNICAL FIELD

This invention relates generally to a computer-based method and system for implementing the billing features of a Wireless Application Protocol (WAP) Gateway. More specifically, the Gateway does not include actual billing software. Instead, the Gateway collects billing data in an information database from which data can be transferred to a separate billing system in a standard format. Because the billing data output from the information database is in the same format as all common telephone billing systems, billing for services used through the Gateway is very convenient.

### BACKGROUND OF THE INVENTION

The demand for wireless services is growing rapidly all around the world. Businesspeople and ordinary consumers lead increasingly mobile lives; they are no longer bound to their home and office computers, but still want to have information at their fingertips whenever they need it. Wireless networks provide people on the move with a medium for easy information access.

The Wireless Application Protocol (WAP) is the de facto world standard for displaying and transmitting information and telephony services on mobile phones and other wireless terminals. The global WAP specification was developed by the industry's top experts as an open standard to implement wireless Internet access. This open standard benefits the whole wireless telecommunication community: carriers, infrastructure vendors, application developers, service providers, and, ultimately, end users. The WAP specification extends existing mobile networking and Internet technologies. It is bearer and device independent, and thus helps foster interoperability.

The WAP programming model is largely based on the WWW programming model with clients and servers. Existing standards have been used as a starting point for WAP technology whenever possible. They have been optimized and extended to provide the best functionality in a wireless environment.

The basic WAP model consists of a client (a WAE user agent, also called a WAP terminal), a gateway, and an origin or content server. A request is sent by an end user through a WAP terminal to a content server on the Internet or in a network. The WAP terminal transmits the request, a standard HTTP request in encoded format, to the gateway. The gateway decodes and processes the request and sends it on to the appropriate content server. The response from the content server is sent back to the gateway over HTTP. The gateway encodes the response and transmits it to the WAP terminal.

The WAP model defines a set of standard components for communication between WAP terminals and content servers:

Standard URL names are used to identify WAP content in a network.

Content is identified by a specific type consistent with WWW typing in order to enable correct processing in the WAP terminal.

Standard content formats based on WWW technology are used.

Standard communications protocols are used to transmit requests from WAP terminals to content servers.

The client device in the WAP programming model is a WAP terminal: a mobile phone or other wireless device used by the end user to request and receive information. A microbrowser in the WAP terminal controls the user interface analogously to a standard Web browser. WAP terminals typically accept data in WML and WMLScript formats. Different types of terminals may also accept bitmaps and other content types.

A WAP gateway communicates with content servers by using the standard HTTP 1.1 protocol. The gateway's location between the WAP terminal and the content server can be compared to that of a standard WWW proxy server. However, a gateway differs from a proxy in that it receives requests from end users as if it were the actual content server for the requested data. The gateway is usually transparent to the end user. The gateway functionality can be added to content servers or placed in a dedicated gateway machine, as in FIG. 1.

The gateway performs most tasks related to WAP use, which minimizes the demand for processing power in the WAP terminal. The use of a gateway allows content and applications to be hosted on standard WWW servers and developed with WWW technologies.

The gateway translates requests from the WAP protocol stack to WWW protocols. It also provides functionality for encoding and decoding data transferred from and to the WAP terminal. WML content from the Internet needs to be encoded in order to minimize the size and number of packets sent to the WAP terminal.

Servers in the WAP model are standard WWW servers that provide WAP content. Content servers can be located on the Internet or in a local network. The content can be anything: stock quotes, weather reports, news headlines, banking services . . . . There are no restrictions to the format of data provided by content servers, but the capabilities of the receiving WAP terminal determines which formats are accepted.

The WAP architecture provides a scalable and extensible environment for further development of applications and devices. The WAP specification defines a lightweight protocol stack that can operate on high-latency, low-bandwidth wireless networks. The stack is located in the gateway and designed so that a variety of networks can run WAP applications. The WAP architecture consists of various layers. External services and applications can use the features provided by different layers through a set of defined interfaces.

WAE is a general application environment based on a combination of WWW and mobile telephony technologies. It provides an interoperable environment for building applications and services that can function in a variety of wireless networks. WAE includes a microbrowser environment for use in WAP terminals.

The session layer is based on modified binary-encoded HTTP 1.1. It provides the application layer with a consistent interface for two modes of session services: connection-oriented and connectionless.

The connection-oriented mode operates above the WTP layer. It provides acknowledgements for request-reply transactions and more reliable service, but uses more bandwidth and processing power in WAP terminals. Connectionless mode operates above WDP. It does not provide acknowledgements, but enables the use of WAP even in narrowband networks and WAP terminals with limited processing power.

Most connections between the WAP terminal and the gateway use WSP regardless of the protocol of the content server from which data is requested. The URL used to request data specifies the protocol used by the content server. Thus, the end user does not need to know what protocol is used in intervening connections.

The transaction layer provides a lightweight, transaction-oriented protocol suitable for implementation in wireless networks. WTP can be compared to traditional TCP in terms of function. However, WTP reduces the amount of information that needs to be transmitted for each request-response transaction, and is thus optimized for wireless use. WTP provides reliability in connections by way of acknowledgements and retransmissions.

The WTLS security protocol is based on the industry standard TLS protocol. WTLS has been optimized for use over narrow-band communication channels and provides features such as data integrity, privacy, authentication, and denial-of-service protection. Most WAP terminals can enable or disable WTLS features depending on the security requirements and the underlying network. The security layer is thus optional in the WAP architecture, but may be used for services such as banking and e-commerce.

The transport layer protocol operates transparently above the bearer services and is adapted to specific features of the underlying bearer. The transport layer provides a common interface for the upper layer protocols (security, transaction, session, and application), which are thus able to function independently of the bearer network.

WAP is designed to operate over different bearer networks. The network layer in the protocol stack supports these bearers. Different bearers offer different levels of service, which the WAP protocols are designed to compensate.

The WAP specification includes the Wireless Markup Language (WML). WML is a tag-based document language that conforms to XML standards and is designed especially for use within the limited computing environment of mobile terminal devices.

From the WAP gateway, all WML content on Web servers is accessed with standard HTTP 1.1 requests. WML documents are divided into units of user interaction called cards and decks. A deck is defined as the entire WML document retrieved (e.g. “Today's news stories”), and a card is the amount of data displayed at once on the WAP terminal (e.g. “First story”, “Second story”). Using cards and decks makes browsing the content faster, as the data does not have to be retrieved from the content server every time the user needs it. The WAP content can be browsed analogously to Web pages: the user can navigate back and forth between cards from one or several decks.

WML provides a variety of features, such as the following:

Content authors can specify text and images presented to the end user.

Layout and presentation on WAP terminals are specified in general terms, which allows independence for device developers.

Support is provided for elements to solicit user input, such as text entries (e.g. passwords) and option selection.

WML allows several navigation mechanisms using URLs and enables international support for different character sets.

WML includes a variety of technologies to optimize communication on narrow-band devices.

WML enables state and context management.

WMLScript is a lightweight, procedural scripting language. It is loosely based on a subset of the industry standard JavaScript™ language, but adapted for optimum use in the narrow-band environment of wireless terminals. WMLScript supports several basic data types and attempts to convert automatically between different types when necessary. WMLScript also supports several categories of operations and functions and defines several standard libraries.

WMLScript is fully integrated with the WML browser in the WAP terminal and enhances the standard browsing and presentation facilities of WML. It enables the WAP terminal to interact with the user in a more intelligent way, for example to check the validity of user input before it is sent to the content server.

Due to the limited processing power of WAP terminals and the requirements of over-the-air transmission, data needs to be sent from the gateway to the WAP terminal in as compact a format as possible. The gateway contains compilers that convert WML and WMLScript into their binary encoded counterparts. Each WML deck is converted into its binary format, WMLC; WMLScript is compiled into low-level bytecode. The compiled data is then sent to the WAP terminal for interpretation and execution.

Many applications on the Internet, such as banking services, require a secure connection between the WAP terminal and the content server. The WAP specification defines a security layer, WTLS, which is used with WAP transport protocols. WAP can provide end-to-end security for connections where the terminal and content server communicate directly using WAP protocols.

The WAP environment supports HTTP 1.1 basic authentication where an end user can be authenticated on the basis of a username and a password. WAP can also use the authentication methods of the underlying bearer network. Bearer network identification and HTTP 1.1 authentication are vital for implementing a standardized, flexible billing regime that is capable of accurately tracking user utilization of services and billing for said utilization. However, because WAP technology is in its infancy, there are few, if any, billing solutions for WAP Gateway use.

Therefore, there is a need in the art for a WAP Gateway implemented, flexible billing system that can be adapted to different business models.

There is a further need in the art for a WAP Gateway implemented billing system that can bill a customer on a transaction basis, time-used basis, or for a predetermined amount of time basis.

There is a further need in the art for a WAP Gateway implemented billing system that can bill a customer in a plurality of manners (e.g. payment in advance or upon receipt of a telephone bill).

There is a further need in the art for a WAP Gateway implemented billing system that can bill a customer depending on which offered services of the Gateway are used by the customer.

There is a further need in the art for a WAP Gateway implemented billing system that can identify and bill specific users by a network bearer address.

There is a further need in the art for a WAP Gateway implemented billing system that allows for a plurality of users to be placed in a group and billed in a uniform manner.

There is a further need in the art for a WAP Gateway implemented billing system whose output data is compatible with standard telephone billing systems.

There is a further need in the art for a WAP Gateway implemented billing system that can cooperate with an Internet service provider to establish a billing plan for the user.

There is a further need in the art for a WAP Gateway implemented billing system that can define payers and payment methods for each service subscription that a user or a group has.

There is a further need in the art for a WAP Gateway implemented billing system that provides a user interface capable of implementing all the features of the system.

There is a further need in the art for a WAP Gateway implemented billing system that is capable of cooperating with data storage equipment and data storage and processing software required for the final billing of users.

### SUMMARY OF THE INVENTION

This invention relates generally to a computer-based system for implementing the billing features of a Wireless Application Protocol (WAP) Gateway. More specifically, the Gateway does not include actual billing software. Instead, the Gateway collects billing data in an information database from which data can be transferred to a separate billing system in a standard format. Because the billing data output from the information database is in the same format as all common telephone billing systems, billing for services used through the Gateway is very convenient.

In a preferred embodiment of the invention, what is provided is a method for billing in a system for providing information over a Wireless Application Protocol Gateway, comprising the steps of initiating a request for information from a Content Server by a consumer using a Wireless Application Protocol compliant device; in response to the request, the system retrieving the information from the Content Server and transmitting the information to the consumer; creating a transaction log on a Knowledge Base of the request and transmission of the information; generating a billing data file using the transaction log; and, processing the billing data file for consumer billing purposes.

In alternative embodiment of the invention, what is provided is a method for billing in a system, comprised of at least one Access Point, a Core, a Knowledge Base, an Administrative Console, a Statistics Module, and, at least one Content Server, for providing information over a Wireless Application Protocol Gateway, comprising the steps of initiating a request for information from a Content Server by a consumer using a Wireless Application Protocol compliant device, wherein the system can identify the If consumer by a network bearer address; in response to the request, the system retrieving the information from the Content Server and transmitting the information to the consumer; creating a transaction log on the Knowledge Base of the request and transmission of the information; generating a billing data file using the transaction log; and, processing the billing data file for consumer billing purposes.

In another alternative embodiment of the invention, what is provided is a method for billing in a system for providing information over a Wireless Application Protocol Gateway, comprising the steps of initiating a request for information from a Content Server by a consumer using a Wireless Application Protocol compliant device, wherein the system can identify the consumer by a network bearer address; in response to the request, the system retrieving the information from the Content Server and transmitting the information to the consumer; creating a transaction log on a Knowledge Base, wherein the transaction log consists of at least one data field, of the request and transmission of the information; generating a billing data file using the transaction log, wherein the billing data file is created by a Structured Query Language query of the transaction log; and, processing the billing data file for consumer billing purposes, wherein the processing factors in at least one billing type and payment method and further, wherein the billing types can be based on a per transactional basis or on a set-time basis.

In another alternative embodiment of the invention, what is provided is a method for set-time billing in a system, comprised of a Core, an Administrative Console, a Statistics Module, and, at least one Content Server, for providing information over a Wireless Application Protocol Gateway, comprising the steps of initiating a request for information from a Content Server by a consumer using a Wireless Application Protocol compliant device, wherein the system can identify the consumer by a network bearer address; confirming availability of service for the consumer on a database; responding to the request, wherein the system retrieves the information from the Content Server and transmits the information to the consumer; and,; and, billing the customer periodically for usage of the service for a set period of time.

In another alternative embodiment of the invention, what is provided is a method for billing in a system providing information over a Wireless Application Protocol Gateway comprised of an Access Point, wherein the Access Point enables consumers to connect to said gateway and further is utilized in a Circuit Switched Data network, whereby incoming traffic from the network is directed through a dialup server over User Datagram Protocol, a Core, wherein the Core transmits requests from consumers to the Content Servers on a global network of computers, and data from the Content Servers back to the consumers, the Core comprised of content adapters, session/transaction handling modules, WAP Stack modules, and Wireless Datagram Protocol modules, a Knowledge Base, wherein the Knowledge Base is a database that contains service definitions and individual user data, the Knowledge Base further saving details of all sessions and transactions in logs that are used to create billing data, an Administrative Console, wherein the Administrative Console is a web-based user interface for administration and management of the Gateway, a Statistics Module, wherein the Statistics Module is in operative communication with the Core via the Administrative Console, the Statistics Module consisting of various counters that monitor different values related to the system status, such as the number of sessions and transactions, memory usage, and system uptime, and, Content Servers, wherein the Content Servers can be located on the Internet or in a local network, comprising initiating a request for information from said Content Server by a consumer using a Wireless Application Protocol compliant device, wherein said system can identify said consumer by a network bearer address; in response to the request, the system retrieving the information from the Content Server and transmitting the information to the consumer; creating a transaction log on said Knowledge Base of the request and transmission of the information; generating a billing data file using the transaction log; and, processing the billing data file for consumer billing purposes.

It is an object of this invention to provide a WAP Gateway implemented, flexible billing system that can be adapted to different business models.

It is a further object of this invention to provide a WAP Gateway implemented billing system that can bill a customer on a transaction basis, time-used basis, or for a predetermined amount of time basis.

It is a further object of this invention to provide a WAP Gateway implemented billing system that can bill a customer in a plurality of manners (e.g. payment in advance or upon receipt of a telephone bill).

It is a further object of this invention to provide a WAP Gateway implemented billing system that can bill a customer depending on which offered services of the Gateway are used by the customer.

It is a further object of this invention to provide a WAP Gateway implemented billing system that can identify and bill specific users by a network bearer address.

It is a further object of this invention to provide a WAP Gateway implemented billing system that allows for a plurality of users to be placed in a group and billed in a uniform manner.

It is a further object of this invention to provide a WAP Gateway implemented billing system whose output data is compatible with standard telephone billing systems.

It is a further object of this invention to provide a WAP Gateway implemented billing system that can cooperate with an Internet service provider to establish a billing plan for the user.

It is a further object of this invention to provide a WAP Gateway implemented billing system that can define payers and payment methods for each service subscription that a user or a group has.

It is a further object of this invention to provide a WAP Gateway implemented billing system that provides a user interface capable of implementing all the features of the system.

It is a further object of this invention to provide a WAP Gateway implemented billing system that is capable of cooperating with data storage equipment and data storage and processing software required for the final billing of users.

### BRIEF DESCRIPTION OF THE DRAWINGS

FIG. 1 A schematic view of the WAP Gateway system architecture.

FIG. 2 A detailed schematic view of the WAP Gateway system architecture.

FIG. 3 A graphic representation of the Billing page.

FIG. 4 A graphic representation of the Administration Console.

FIG. 5 A schematic view of the Administration Console.

FIG. 6 A continued schematic view representation of the Administration Console.

FIG. 7 A graphic representation of the Global Prices page.

FIG. 8 A graphic representation of the New Price page.

FIG. 9 A graphic representation of the Services page.

FIG. 10 A graphic representation of the New Service page.

FIG. 11 A graphic representation of the Edit Service page.

FIG. 12 A graphic representation of the Service Billing Option page.

FIG. 13 A graphic representation of the Subscriptions page.

FIG. 14 A graphic representation of the Subscription Edit page.

FIG. 15 A graphic representation of the New Subscription Billing Parameter page.

FIG. 16 A graphic representation of the Subscription Billing Parameters page.

FIG. 17 A chart of transaction log data fields.

FIG. 18 A chart of additional fields required by the CDR output file.

### DETAILED DESCRIPTION OF THE PREFERRED EMBODIMENT OF THE PRESENT INVENTION

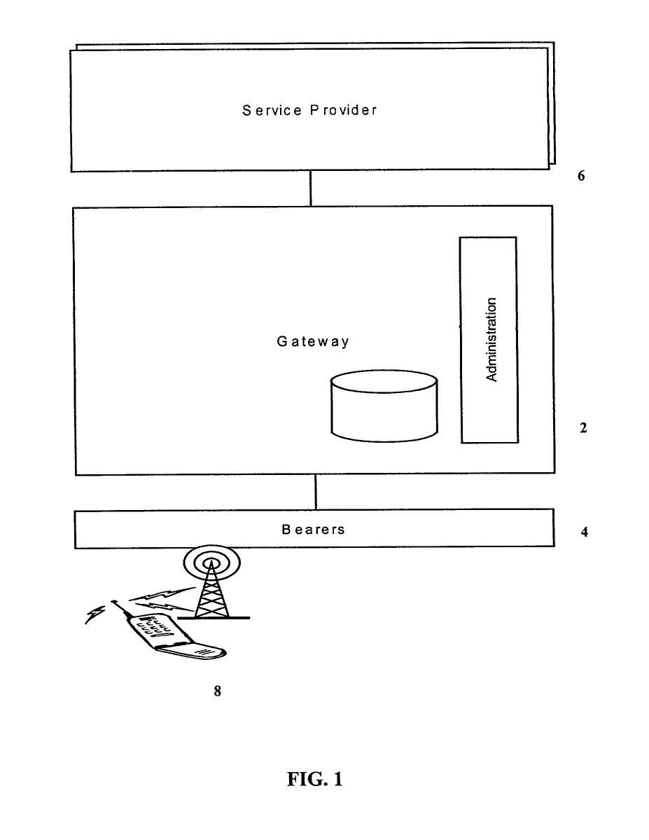

A major feature of the Gateway 2, FIG. 1, is a flexible billing solution that can be adapted to different business models. Various billing criteria can be used between the Gateway 2 operator, the Service Provider 6, and the end user 8. For example, services through the Gateway 2 can be free, i.e. billing is not implemented through the Gateway 2, even if the Service Provider 6 charges a separate fee for the information provided. When billing is implemented through the Gateway 2, it is based on the number of transactions performed by the end user 8, i.e. the amount of WAP services used. The user's 8 transactions are logged based on the bearer address and billed later. The Gateway 2 also supports advance payment services where the end user 8 pays for unlimited access to services for a predefined time, one month for example.

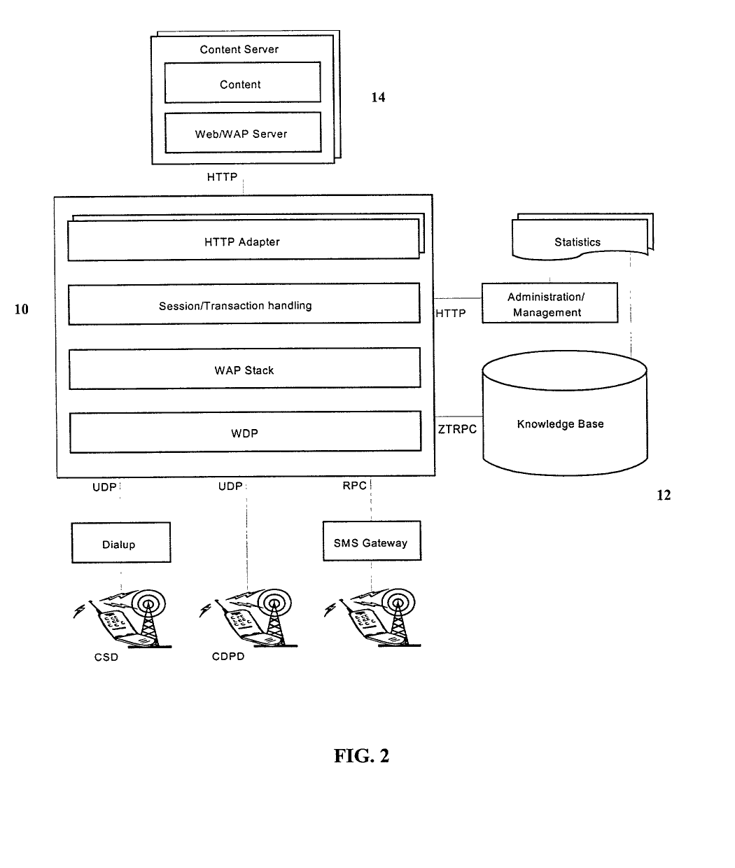

There are various available Gateway 2 billing types and payment methods. The Gateway Core 10, in FIG. 2, identifies end users 8 by their bearer addresses, e.g. the WAP terminal's Mobile Station International ISDN Number (MSISDN). Each user/group has different billing options for each subscribed service.

There are two ways for the end user 8 to pay for using services through the Gateway 2:

Billing can be based on the amount of transactions the user 8 has made, or

The user 8 can pay for access to the Gateway 2 for a certain time (e.g. a month).

Payment can take place:

In advance, or

Later, e.g. with the telephone bill.

This combination of billing type and payment method is called a billing model. Different services can be priced differently. If you choose a billing model that includes access level control, you have to set a different price for every access level. The WAP Gateway 2 supports the following seven billing models:

FREE=free browsing—The Gateway 2 use is free of charge, i.e., billing data is not collected through the Gateway 2, even if the Service Provider 6 charges for the information provided or the telephone operator charges for the call made. The free use option is technically similar to the unlimited access in the time frame option. You activate the subscription but do not define an end time.

TRANSACTION=transaction-based billing/all services—In addition to defining billing models for each service, you can define a global billing model to the system. If you choose to use a global transaction-based model, you still have to assign the model to all services, but you don't have to select price options for each service separately. The transaction price is constant for all services, i.e. end users 8 pay the same price for each transaction regardless of which services they use.

TRANSSERVICE=transaction-based billing/service-specific—The end user 8 pays for each transaction through the Gateway 2. Billing is based on the number of transactions. You can set a different transaction price category for each service.

TRANSACCLEVEL=transaction-based billing/service-specific/access level control—Access level control is enabled for the service.

SUBSCRIPTION=unlimited access in a time frame/all services—You can also define a global, time-based billing model. The price per time unit is constant for all services, i.e., the end users 8 pay the same price for a certain time of Gateway 2 access regardless of which services they use during this time.

SUBSCRSERVICE=unlimited access in a time frame/service-specific—The end user 8 has access through the Gateway 2 to a certain service for a certain price for a certain time frame.

SUBSCRACCLEVEL=unlimited access in a time frame/service-specific/access level control—Access level control is enabled for the service.

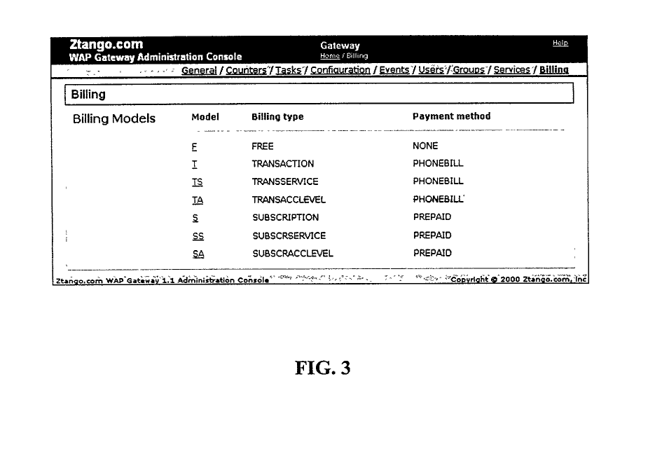

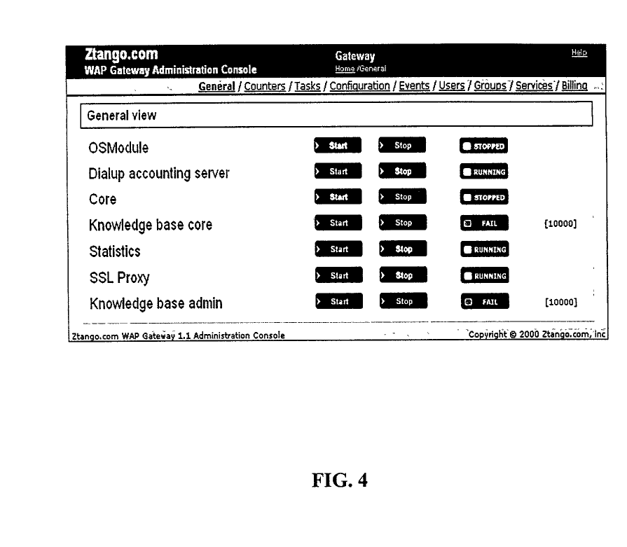

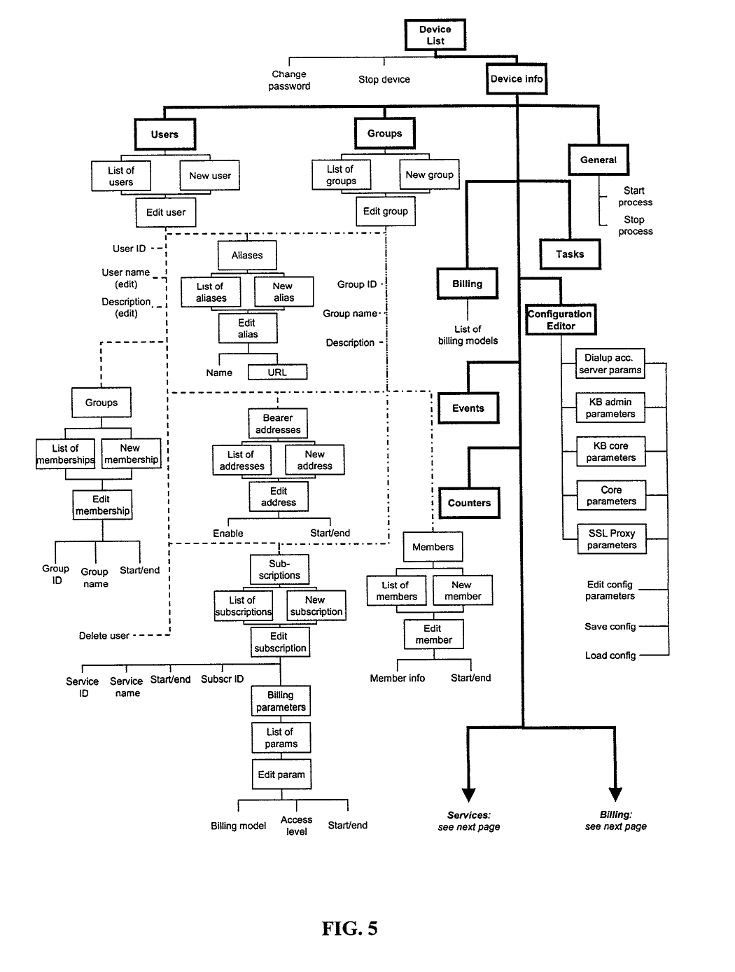

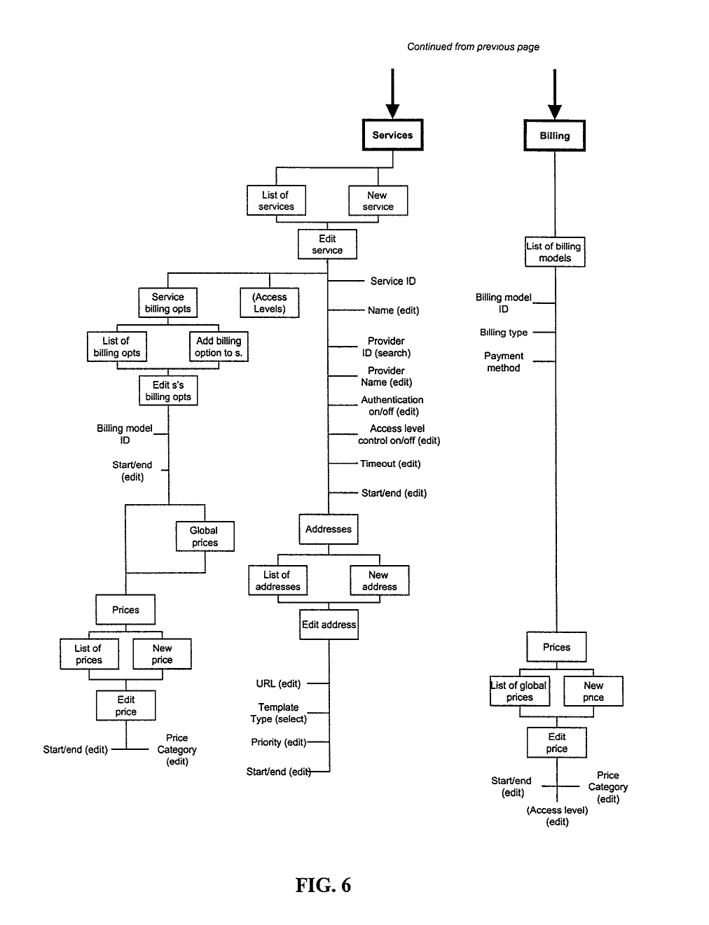

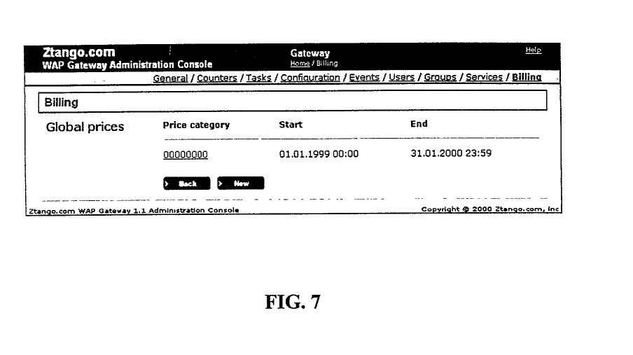

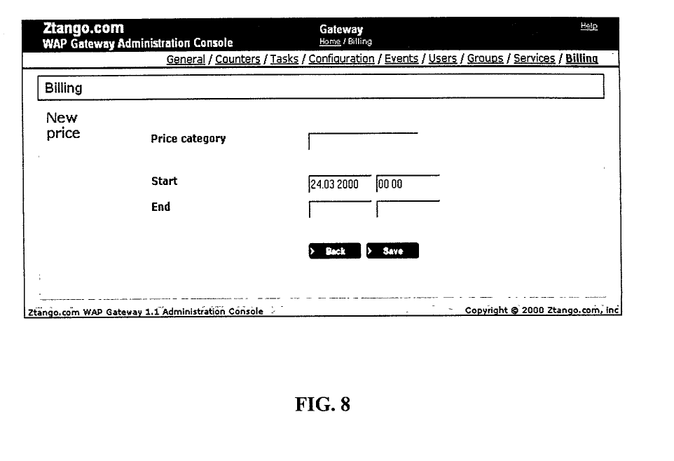

Global prices are prices defined for billing models. One billing model can include several price categories. You can edit global prices through the Billing page, FIG. 3. To add a global price category to a billing model an administrator must click Billing in the Administration Console, FIG. 4, for a schematic see FIGS. 5 and 6. The Billing page FIG. 3 opens, displaying a list of available global billing models. In the list, click the billing model you want to modify. The model's Global Prices page FIG. 7 opens. To edit a price category, click it in the list or click New. This displays the New Price page FIG. 8. In the Price category text box, enter a name for the price category. In the Start text boxes, specify the date and the time when the price becomes valid. In the End text boxes, specify the date and the time when the price ceases to be valid. Click Save. Click Ok.

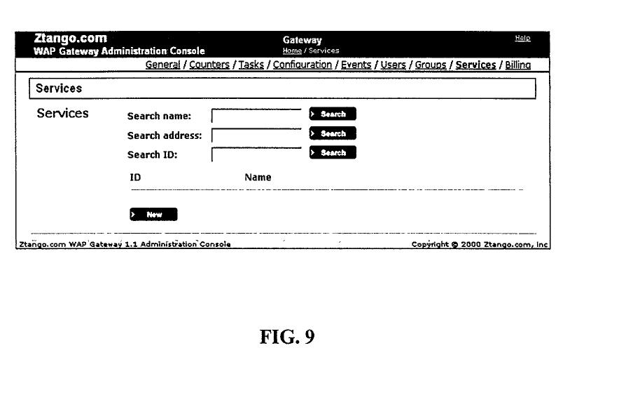

Billing models are assigned when the service is created in the Knowledge Base 12. Service management in the Gateway Knowledge Base 12 involves adding, editing and removing Service Providers 6 and services. Services can be added, viewed, edited, and removed on the Services page, FIG. 9, of the Administration Console, FIG. 4. A service consists of information available on a Service Provider's 6 content server 14. The end users 8 can access the services with their WAP terminals via the Gateway 2. If you want to charge the end users 8 for the requests they make to content servers 14 via the Gateway 2, add the service in the Gateway Knowledge Base 12.

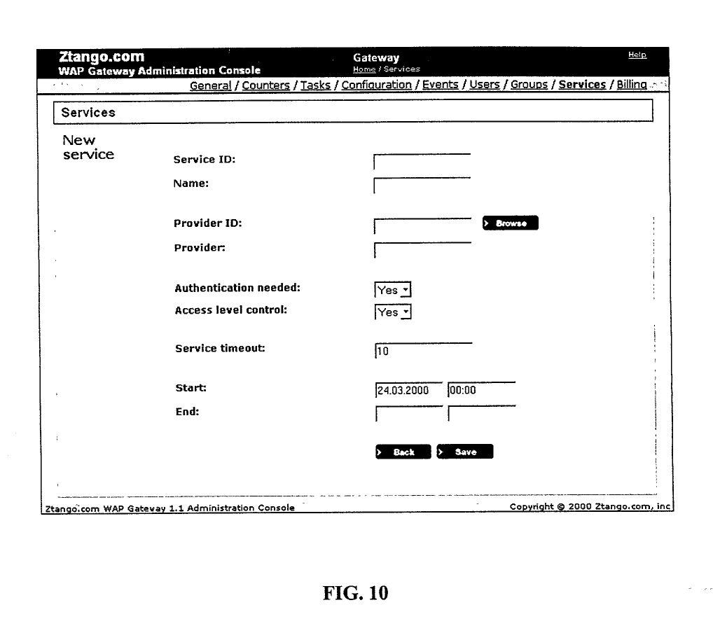

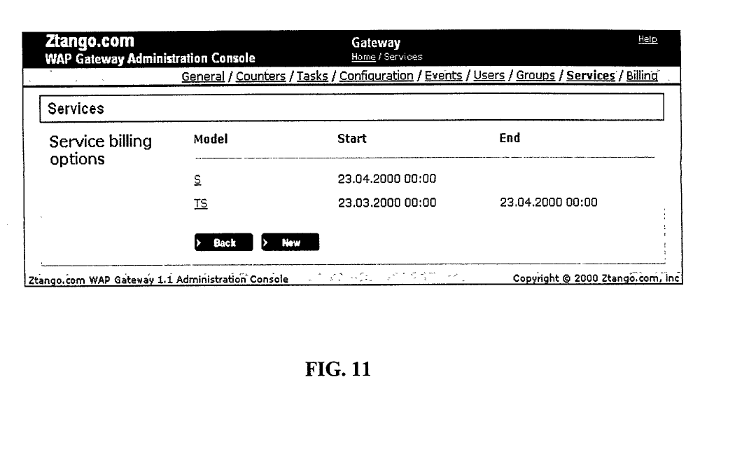

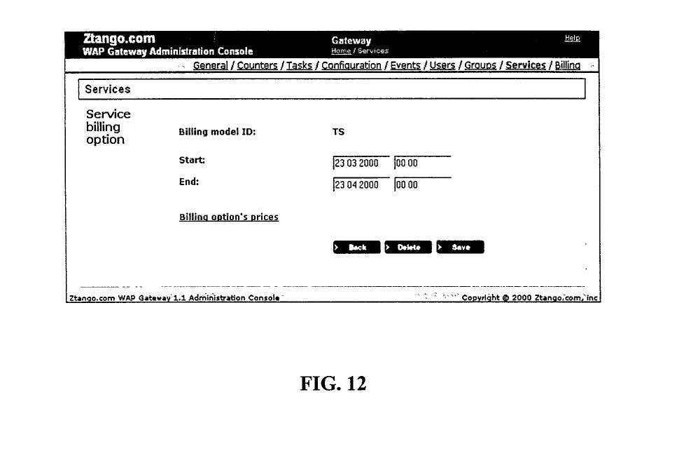

A service's billing options consist of the billing models chosen for the service and the time that each billing model is valid. A billing model, in turn, consists of two variables: price and billing criteria. To define service billing options click the Billing options link on the New service FIG. 10 or Edit service FIG. 11 page. A list of the service's billing options is displayed. If the service is new, the list is empty. To modify a billing option, click its Model in the list or Click New. The Service billing option page FIG. 12 opens. What appears on the page FIG. 12 depends on the model of the option you are editing. If the service's Billing model uses global pricing, the Global prices link appears. If the service uses individual prices, the Billing option's prices link appears. Modify the Start and End text boxes as desired. Click Save. Click Ok.

To view and edit prices click the Global prices or Billing option's prices link on the Service billing option page FIG. 12. A list of prices is displayed. To edit a price category, click it in the list or On the Service billing option prices page FIG. 12, click New. In the Price category text box, enter a name for the price category. In the Start text boxes, specify the date and the time when the price becomes valid. In the End text boxes, specify the date and the time when the price ceases to be valid. Click Save. Click Ok.

These billing models are only valid when using services through the Gateway 2. In addition to the Gateway 2 provider, telephone operators and Service Providers 6 can also charge the end user 8. You can combine these billing models with all their business models.

In order to enable billing and to limit access to services, the Gateway 2 needs to identify the end users 8. User 8 authentication is automatic. When an end user 8 requests a service, the Gateway 2 maps the requested address to a Uniform Resource Locator (URL). Then the Gateway 2 checks if authentication is required. If it is, the Gateway 2 checks if there is a match for the end user's 8 WAP terminal's bearer network address, for instance an MSISDN, in the user 8 records of the Knowledge Base 12 and if the user 8 has a valid subscription to the requested service. If the user 8 is found in the Knowledge Base 12 and if the user 8 has a valid subscription to the service, the Gateway 2 transmits the response to the user's 8 terminal. For services that do not require authentication the subscription check is not performed.

If the Service Provider 6 wishes to offer different service levels to different users 8, the Provider 6 can set up access levels. By selecting the access level control option you can grant access to certain parts of the service that only users 8 with the appropriate access rights can access.

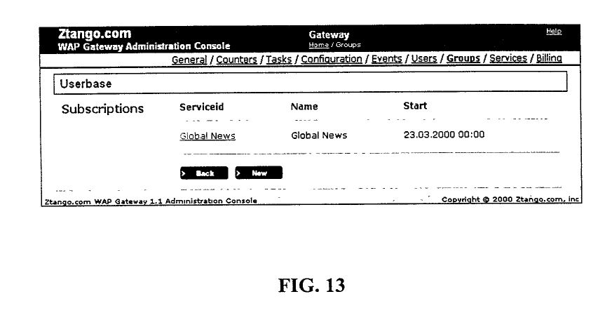

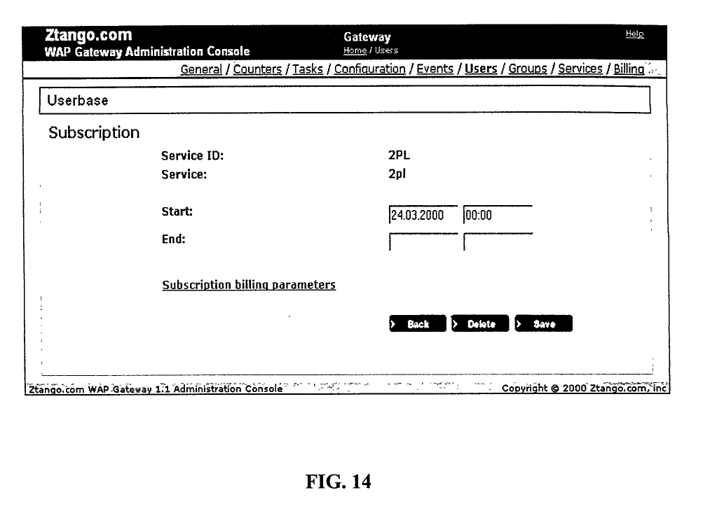

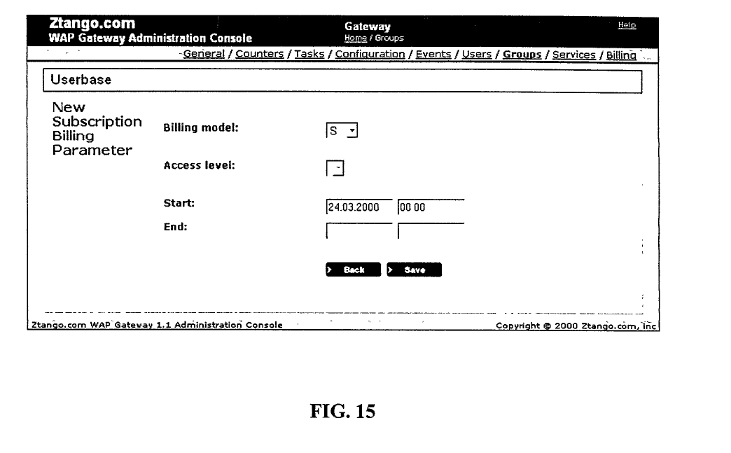

To add a billing parameter for a subscription, find the user or group in the Knowledge Base 12. Click the Subscriptions link. The Subscriptions page FIG. 13 opens, displaying a list of subscriptions. In the list of subscriptions, click the subscription you want to view or modify. The subscription's edit page FIG. 14 opens. Click the Subscription billing parameters link. A list of the subscription's billing parameters is displayed. If the subscription is new, the list is empty. Click New. The New Subscription Billing Parameter page FIG. 15 opens. In the Billing model drop-down box, select a billing model. In the Access level drop-down box, select an access level for the user 8. In the Start text boxes, enter the date and the time when the subscription becomes valid. In the End text boxes, enter the date and the time when the subscription ceases to be valid. Click Save. Click Ok.

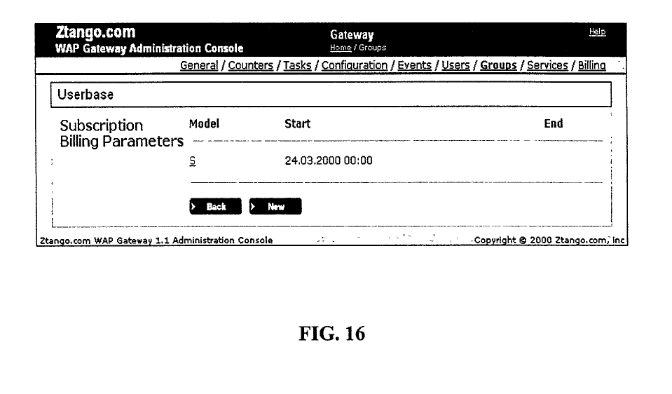

You can define payers and payment methods for each service subscription that a user or a group has. These options must be defined so that only one set is valid at a time. To set a subscription's billing options Find the user or group in the Knowledge Base 12. Navigate to the subscription you want to modify. Click the Subscription billing parameters link. The user's Subscription Billing Parameters page FIG. 16 opens. Click New. The New Subscription Parameter page FIG. 15 opens. In the Billing model drop-down box, select the billing model you want to apply to the subscription. If access level control has been enabled for the service in question, select an access level for the user or group. In the Start text boxes, enter the date and the time when the billing parameter becomes valid. In the End text boxes, enter the date and the time when the billing parameter ceases to be valid. Click Save. Click Ok.

The billing models where the payment method is phonebill allow you to define a payer who is different from the user (or group) who actually subscribes to the service. The payer must be a user 8 with a user account in the Knowledge Base 12. To define a payer, find the user or group in the Knowledge Base 12. Navigate to the subscription you want to modify. Create a new subscription billing parameter, selecting a billing model with phonebill defined as the payment method. Click Save. Click Ok. The Edit Subscription Billing Parameter page opens. In the Payer ID text box, enter the ID of the user 8 you want to define as payer or Click Browse to locate the payer in the Knowledge Base 12. Click Save. Click Ok.

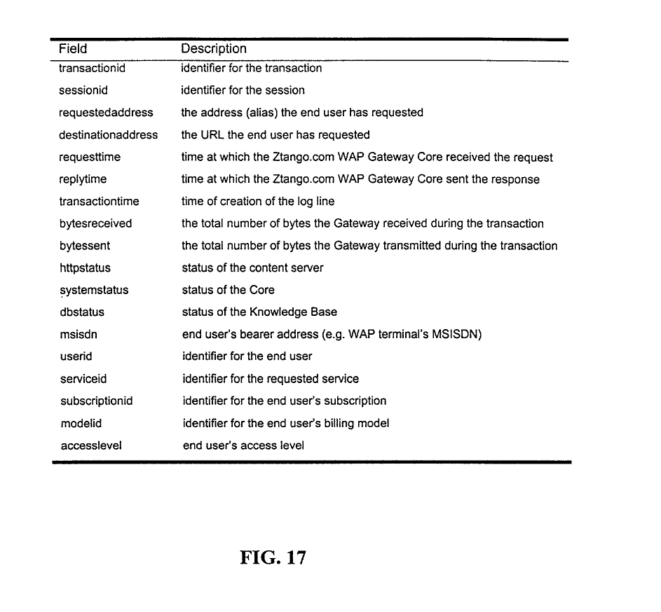

The Gateway 2 generates log tables in the Knowledge Base 12. The basic data needed for billing is saved in a transaction log. Each transaction creates a new record with the fields shown in FIG. 17. Each record is made up of data fields. These fields contain identifiers that have been assigned to the end user 8 or the service during set-up, or identifiers that the Gateway 2 has given to processes. There are also fields that contain information about addresses, times, the statuses of the various parts of the system, and traffic at the system interfaces.

Before you can create invoices based on this information, you have to transfer the data to a separate billing system. The data being transferred must be in Call Data Record (CDR) format. The necessary CDR file is created by automatic Structured Query Language (SQL) queries to the Knowledge Base 12.

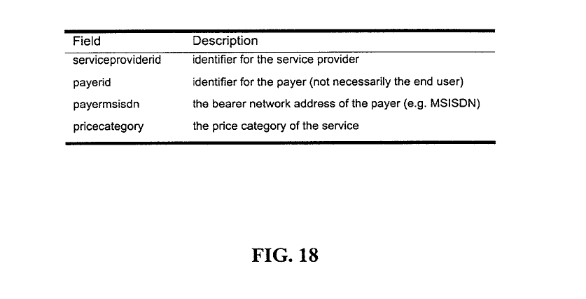

A CDR file is a text file where each record represents a transaction. The data for a CDR record is retrieved from the related transaction log record by an automatic SQL query, which regularly, e.g. once a day, generates the CDR file. The generation interval is set when installing the Gateway 2 product. The CDR file contains all the information needed to charge the end user 8 for the use of services through the Gateway 2. It does not necessarily include all the parameters shown in the transaction log. In fact, you also have to retrieve values from other parts of the Knowledge Base 12. These additional fields are shown in FIG. 18.

The structure of the CDR file is always defined when the Gateway 2 product is installed for the first time. However, you may need to change the settings if, for example, you change your billing software. You can access the settings any time using a SQL view to the Knowledge Base 12.

Accordingly, it will be understood that the preferred embodiment of the present invention has been disclosed by way of example and that other modifications and alterations may occur to those skilled in the art without departing from the scope and spirit of the appended claims.

What is claimed is:

1. A method for billing in a system for providing information over a Wireless Application Protocol Gateway, comprising the steps of:
initiating a request for information from a Content Server by a consumer using a Wireless Application Protocol compliant device;
in response to said request, said system retrieving said information from said Content Server and transmitting said information to said consumer;
creating a transaction log on a Knowledge Base of said request and transmission of said information;
generating a billing data file using said transaction log; and,
processing said billing data file for consumer billing purposes.

2. The method of claim 1, wherein said transaction log consists of at least one data field.

3. The method of claim 1, wherein said billing data file is in Call Data Record format.

4. The method of claim 1, wherein said billing data file is created by a Structured Query Language query of the transaction log.

5. The method of claim 1, wherein said processing factors in at least one billing type and payment method.

6. The method of claim 5, wherein said billing types can be based on a per transactional basis or on a set-time basis.

7. The method of claim 5, wherein said payment methods can take place in advance or later.

8. The method of claim 5, wherein said billing types and payment methods can be combined into a plurality of billing models.

9. The method of claim 8, wherein said billing models are assigned to said consumer when the service is created in said Knowledge Base.

10. The method of claim 8, wherein said billing models can be combined with the billing models of the telephone companies and the service providers.

11. The method of claim 1, wherein a plurality of consumers can be placed in a consumer group and billed in a uniform manner.

12. The method of claim 1, wherein payers and payment methods can be defined for each service subscription that a consumer or a consumer group has.

13. A method for billing in a system, comprised of at least one Access Point, a Core, a Knowledge Base, an Administrative Console, a Statistics Module, and, at least one Content Server, for providing information over a Wireless Application Protocol Gateway, comprising the steps of:
initiating a request for information from a Content Server by a consumer using a Wireless Application Protocol compliant device, wherein said system can identify said consumer by a network bearer address;
in response to said request, said system retrieving said information from said Content Server and transmitting said information to said consumer;
creating a transaction log on said Knowledge Base of said request and transmission of said information;
generating a billing data file using said transaction log; and,
processing said billing data file for consumer billing purposes.

12. The method of claim 11, wherein said transaction log consists of at least one data field.

13. The method of claim 11, wherein said billing data file is in Call Data Record format.

14. The method of claim 11, wherein said billing data file is created by a Structured Query Language query of the transaction log.

15. The method of claim 11, wherein said processing factors in at least one billing type and payment method.

16. The method of claim 15, wherein said billing types can be based on a per transactional basis or on a set-time basis.

17. The method of claim 15, wherein said payment methods can take place in advance or later.

18. The method of claim 15, wherein said billing types and payment methods can be combined into a plurality of billing models.

19. The method of claim 18, wherein said billing models are assigned to said consumer when the service is created in said Knowledge Base, and said consumer is billed by said consumer's network bearer address.

20. The method of claim 18, wherein said billing models can be combined with the billing models of the telephone companies and the service providers.

21. The method of claim 1, wherein a plurality of consumers can be placed in a consumer group and billed in a uniform manner.

22. The method of claim 1, wherein payers and payment methods can be defined for each service subscription that a consumer or a consumer group has.

23. A method for billing in a system for providing information over a Wireless Application Protocol Gateway, comprising the steps of:
initiating a request for information from a Content Server by a consumer using a Wireless Application Protocol compliant device, wherein said system can identify said consumer by a network bearer address;
in response to said request, said system retrieving said information from said Content Server and transmitting said information to said consumer;
creating a transaction log on a Knowledge Base, wherein said transaction log consists of at least one data field, of said request and transmission of said information;
generating a billing data file using said transaction log, wherein said billing data file is created by a Structured Query Language query of the transaction log; and,
processing said billing data file for consumer billing purposes, wherein said processing factors in at least one billing type and payment method and further, wherein said billing types can be based on a per transactional basis or on a set-time basis.

24. The method of claim 23, wherein said billing data file is in Call Data Record format.

25. The method of claim 23, wherein said payment methods can take place in advance or later.

26. The method of claim 23, wherein said billing types and payment methods can be combined into a plurality of billing models.

27. The method of claim 26, wherein said billing models are assigned to said consumer when the service is created in said Knowledge Base, and said consumer is billed by said consumer's network bearer address.

28. The method of claim 26, wherein said billing models can be combined with the billing models of the telephone companies and the service providers.

29. The method of claim 23, wherein a plurality of consumers can be placed in a consumer group and billed in a uniform manner.

30. The method of claim 23, wherein payers and payment methods can be defined for each service subscription that a consumer or a consumer group has.

31. A method for set-time billing in a system, comprised of a Core, an Administrative Console, a Statistics Module, and, at least one Content Server, for providing information over a Wireless Application Protocol Gateway, comprising the steps of:
initiating a request for information from a Content Server by a consumer using a Wireless Application Protocol compliant device, wherein said system can identify said consumer by a network bearer address;
confirming availability of service for said consumer on a database;
responding to said request, wherein said system retrieves said information from said Content Server and transmits said information to said consumer; and,
billing said customer periodically for usage of said service for a set period of time.

32. The method of claim 31, wherein said billing produces a billing data file in Call Data Record format.

33. The method of claim 32, wherein said billing data file is created by a Structured Query Language of the consumers in the database.

34. The method of claim 31, further comprising said consumer paying in advance or later.

35. The method of claim 38, wherein said consumer is billed by said consumer's network bearer address.

36. The method of claim 38, wherein said billing can be combined with the billing of the telephone companies and the service providers.

37. The method of claim 31, wherein said system further comprises at least one Access Point.

38. The method of claim 31, wherein a plurality of consumers can be placed in a consumer group and billed in a uniform manner.

39. The method of claim 31, wherein payers and payment methods can be defined for each service subscription that a consumer or a consumer group has.

40. A method for billing in a system providing information over a Wireless Application Protocol Gateway comprised of an Access Point, wherein said Access Point enables consumers to connect to said gateway and further is utilized in a Circuit Switched Data network, whereby incoming traffic from said network is directed through a dialup server over User Datagram Protocol, a Core, wherein said Core transmits requests from consumers to said Content Servers on a global network of computers, and data from said Content Servers back to the consumers, said Core comprised of content adapters, session/transaction handling modules, WAP Stack modules, and Wireless Datagram Protocol modules, a Knowledge Base, wherein said Knowledge Base is a database that contains service definitions and individual user data, said Knowledge Base further saving details of all sessions and transactions in logs that are used to create billing data, an Administrative Console, wherein said Administrative Console is a web-based user interface for administration and management of said Gateway, a Statistics Module, wherein said Statistics Module is in operative communication with said Core via said Administrative Console, said Statistics Module consisting of various counters that monitor different values related to the system status, such as the number of sessions and transactions, memory usage, and system uptime, and, Content Servers, wherein said Content Servers can be located on the Internet or in a local network, comprising:
initiating a request for information from said Content Server by a consumer using a Wireless Application Protocol compliant device, wherein said system can identify said consumer by a network bearer address;
in response to said request, said system retrieving said information from said Content Server and transmitting said information to said consumer;
creating a transaction log on said Knowledge Base of said request and transmission of said information;
generating a billing data file using said transaction log; and,
processing said billing data file for consumer billing purposes.

41. The method of claim 40, wherein said transaction log consists of at least one data field.

42. The method of claim 40, wherein said billing data file is in Call Data Record format.

43. The method of claim 40, wherein said billing data file is created by a Structured Query Language query of the transaction log.

44. The method of claim 40, wherein said processing factors in at least one billing type and payment method.

45. The method of claim 44, wherein said billing types can be based on a per transactional basis or on a set-time basis.

46. The method of claim 44, wherein said payment methods can take place in advance or later.

47. The method of claim 44, wherein said billing types and payment methods can be combined into a plurality of billing models.

48. The method of claim 47, wherein said billing models are assigned to said consumer when the service is created in said Knowledge Base, and said consumer is billed by said consumer's network bearer address.

49. The method of claim 47, wherein said billing models can be combined with the billing models of the telephone companies and the service providers.

50. The method of claim 40, wherein a plurality of consumers can be placed in a consumer group and billed in a uniform manner.

51. The method of claim 40, wherein payers and payment methods can be defined for each service subscription that a consumer or a consumer group has.

52. The method of claim 40, wherein said system further comprises an Access Point, utilized in a Short Message Service network.

53. The method of claim 40, wherein said system further comprises content adapters that are interchangeable for version and new protocol upgrades.

54. The method of claim 40, wherein said system further comprises a WAP Stack, through binary encoding and decoding, that handles all content transmissions, retransmissions, and acknowledgements related to connections between said Gateway and the consumer.

55. The method of claim 40, wherein said system further comprises a Core that is in operative communication with said Knowledge Base, said Administrative Console, said Content Servers and said Access Points.

56. The method of claim 40, wherein said Core further communicates with said Knowledge Base for necessary user information such as service plan, billing, and user preferences.

57. The method of claim 40, wherein said system further comprises an Administrative Console that also displays system events and the alerts resulting from said events.

58. The method of claim 40, wherein said Administrative Console further utilizes said Statistics Module to display system statistics reflecting the amount and type of traffic at each Gateway interface.

59. The method of claim 40, wherein values of said counters are logged regularly in a separate file for retrieval and viewing.
